(19) United States
(12) Patent Application Publication
(10) Pub. No.: US 2022/0397080 A1
(43) Pub. Date: Dec. 15, 2022

(54) THRUSTER NOZZLE ASSEMBLY WITH FLOW REGULATOR IN THROAT AREA AND ROTARY JOINT

(71) Applicant: Aerojet Rocketdyne, Inc., Sacramento, CA (US)

(72) Inventors: Kevin Mark Noonan, Madison, AL (US); Robert Cooper, Madison, AL (US); Larry Kenneth West, Shingles Springs, CA (US)

(21) Appl. No.: 17/771,237

(22) PCT Filed: Dec. 10, 2019
(86) PCT No.: PCT/US2019/065369

§ 371 Date: Apr. 22, 2022

(51) Int. Cl. F02K 9/84; F02K 9/86

(52) U.S. Cl. CPC F02K 9/84; F02K 9/86

(57) ABSTRACT

A nozzle assembly according to an exemplary aspect of the present disclosure includes, among other things, a nozzle including a throat section. The nozzle further includes a ball portion of a ball and socket joint. The assembly further includes a vehicle including a socket portion of the ball and socket joint. The nozzle is mounted to the vehicle and the ball portion is received at least partially in the socket portion. A flow regulator is arranged adjacent the throat section and configured to regulate a flow of fluid through the throat section. The flow regulator is attached to the nozzle upstream of the throat section. An actuator is attached to the nozzle, and the actuator is configured to selectively rotate the nozzle via the ball and socket joint about a first axis normal to a longitudinal axis of the vehicle. A rocket and method are also disclosed.

### BACKGROUND

Thrusters, such as those for rocket engines, other aerospace vehicles, ground vehicles, marine vehicles, or other systems, are known to include convergent-divergent nozzles which expel a high-speed propulsive jet of fluid. Thrusters may also include regulator valves to deliver the pressurized fluid at a desired pressure.

### SUMMARY

A nozzle assembly according to an exemplary aspect of the present disclosure includes, among other things, a nozzle including a throat section. The nozzle further includes a ball portion of a ball and socket joint. The assembly further includes a vehicle including a socket portion of the ball and socket joint. The nozzle is mounted to the vehicle and the ball portion is received at least partially in the socket portion. A flow regulator is arranged adjacent the throat section and configured to regulate a flow of fluid through the throat section. The flow regulator is attached to the nozzle upstream of the throat section. An actuator is attached to the nozzle, and the actuator is configured to selectively rotate the nozzle via the ball and socket joint about a first axis normal to a longitudinal axis of the vehicle.

In a further non-limiting embodiment of the foregoing nozzle assembly, the actuator is further configured to selectively rotate the nozzle about a second axis normal to the longitudinal axis of the vehicle and the first axis.

In a further non-limiting embodiment of any of the foregoing nozzle assemblies, the assembly includes a plurality of nozzles and a corresponding plurality of flow regulators, and each of the plurality of nozzles is integral to the ball portion of the ball and socket joint.

In a further non-limiting embodiment of any of the foregoing nozzle assemblies, each of the plurality of flow regulators is configured to operate either independent of one another or in coordination with one another.

In a further non-limiting embodiment of any of the foregoing nozzle assemblies, the ball portion is a semi-spherical bearing and the socket portion a semi-spherical socket surrounding at least a portion of the ball portion.

In a further non-limiting embodiment of any of the foregoing nozzle assemblies, the flow regulator includes a pintle moveable in a direction parallel to a longitudinal axis of the nozzle relative to a seat to regulate the flow of fluid through the throat area.

In a further non-limiting embodiment of any of the foregoing nozzle assemblies, the pintle includes a includes a shank portion, a head portion having a greater diameter than the shank portion, and a tapered surface extending from the head portion, the tapered surface is configured to contact the seat, and a linear position of the tapered surface relative to the seat changes a size of a flow area through which fluid can flow through the throat section.

In a further non-limiting embodiment of any of the foregoing nozzle assemblies, the tapered surface gradually reduces in diameter from the head portion to a free end of the pintle.

In a further non-limiting embodiment of any of the foregoing nozzle assemblies, the pintle is one of a plurality of pintles arranged adjacent the throat section, and each of the plurality of pintles is independently moveable.

In a further non-limiting embodiment of any of the foregoing nozzle assemblies, the plurality of pintles consists of four pintles spaced-apart from one another about the longitudinal axis of the nozzle.

In a further non-limiting embodiment of any of the foregoing nozzle assemblies, the assembly includes a plurality of linear actuators each configured to selectively move a respective one of the plurality of pintles.

In a further non-limiting embodiment of any of the foregoing nozzle assemblies, the nozzle includes a divergent section extending from the throat section.

In a further non-limiting embodiment of any of the foregoing nozzle assemblies, the vehicle is a rocket engine.

A rocket according to an exemplary aspect of the present disclosure includes, among other things, a body, propellant stored within the body, a combustion chamber arranged within the body, and a nozzle assembly attached to the body and configured to expel the products of the combustion chamber. The nozzle assembly includes a nozzle including a throat section, a flow regulator arranged adjacent the throat section and configured to regulate a flow of the products of the combustion chamber through the throat section, and a rotary ball joint configured to selectively rotate the flow regulator and nozzle.

In a further non-limiting embodiment of the foregoing rocket, the flow regulator includes a pintle linearly moveable relative to a seat.

In a further non-limiting embodiment of any of the foregoing rockets, the pintle is one of a plurality of pintles arranged adjacent the throat section, and each of the plurality of pintles is independently moveable by a respective linear actuator.

In a further non-limiting embodiment of any of the foregoing rockets, the plurality of pintles consists of four pintles spaced-apart from one another about a longitudinal axis of the nozzle.

A method according to an exemplary aspect of the present disclosure includes, among other things, thrust vectoring a body by adjusting a position of a nozzle relative to the body via a rotary joint and adjusting a position of a flow regulator arranged adjacent a throat section of the nozzle.

In a further non-limiting embodiment of the foregoing method, the flow regulator includes a pintle, and wherein adjusting the position of the flow regulator includes linearly moving the pintle in a direction parallel to a longitudinal axis of the nozzle.

### BRIEF DESCRIPTION OF THE DRAWINGS

FIG. 1 schematically illustrates an example rocket including an example nozzle assembly.

FIG. 2 illustrates an example flow regulator.

FIG. 3 illustrates an example rotary ball joint.

FIG. 4 illustrates a second example nozzle assembly.

### DETAILED DESCRIPTION

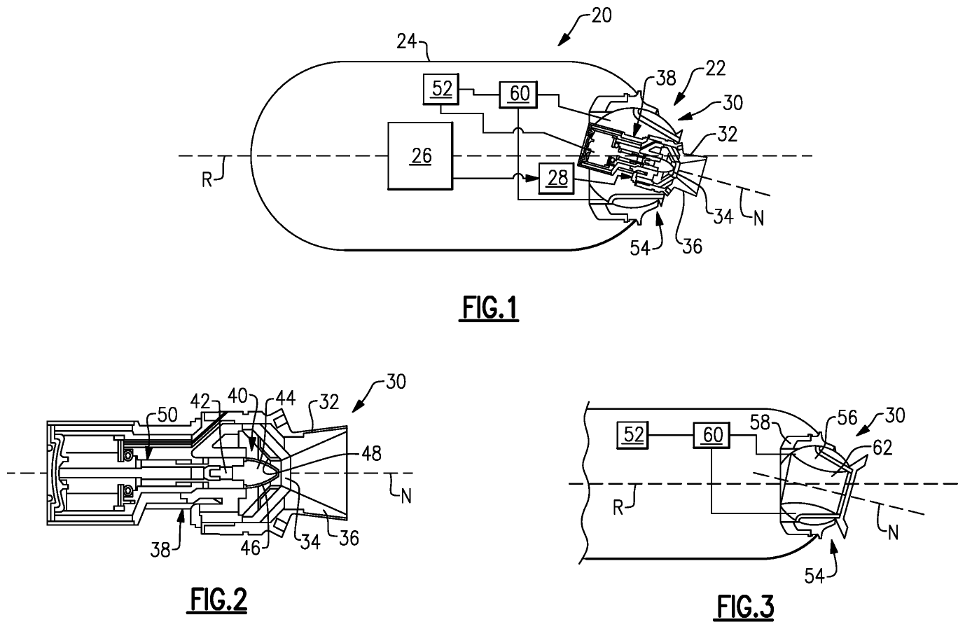

FIG. 1 schematically illustrates a vehicle 20, which could be a rocket, missile, spacecraft, aircraft, or other vehicle. The vehicle 20 obtains thrust from a thruster 22, which in this example is a rocket engine. While a vehicle and rocket engine are shown in FIG. 1 and discussed herein, this disclosure is not limited to rockets or rocket engines, and specifically applies to nozzle assemblies for other vehicles, including space, air, land and marine vehicles. This disclosure also applies to nozzle assemblies for thrusters in reaction control systems.

The vehicle 20 generally extends along a longitudinal vehicle axis R, and in this example includes a casing 24 extending along the longitudinal vehicle axis R. The casing 24 is an outer body of the vehicle 20. The casing 24 may be a one-piece or multi-piece structure.

At least one propellant 26 is stored within the casing 24. The propellant 26 may be a mono-propellant stored in a single tank or two separate propellants, namely fuel and an oxidizer, stored in separate tanks. The propellant 26 is fluidly coupled to a combustion chamber 28 arranged within the casing 24. The combustion chamber 28 is fluidly coupled to a nozzle assembly 30. While propellant and a combustion chamber are mentioned herein, this disclosure extends to thrusters without a combustion chamber, including cold gas thrusters and nuclear thermal rockets.

The nozzle assembly 30 is configured to expel a high-speed propulsive jet of the fluid to provide thrust for the vehicle 20. Specifically, in this example, the nozzle assembly 30 is configured to expel the products of the combustion chamber 28.

The nozzle assembly 30 includes a nozzle 32 including a narrow, throat section 34 and a divergent section 36 extending from the throat section 34 along a longitudinal nozzle axis N. The divergent section 36 gradually increases in diameter as the divergent section 36 extends away from the throat section 34 along the longitudinal nozzle axis N.

The nozzle assembly 30 includes a flow regulator 38, which is shown in detail in FIG. 2. The flow regulator 38 is arranged adjacent the throat section 34 and is configured to regulate a flow of fluid (i.e., the products of the combustion chamber 28) through the throat section 34. In this example, the flow regulator 38 includes a pintle 40 having a shank portion 42 and a head portion 44 providing a tapered surface 46 gradually reducing in diameter toward a free end of the head portion 44. The tapered surface 46 which faces a seat 48 and is configured to contact the seat 48 in a closed position. Relative spacing between the tapered surface 46 relative to the seat 48 sets a size of a flow area through which fluid can flow through the throat section 34. The relative position of the tapered surface 46 and the seat 48 may be infinitely adjustable in one example. In this sense, the flow regulator 38 is moveable between a closed position and a number of open positions.

The tapered surface 46 is selectively moveable relative to the seat 48 in a direction parallel to the longitudinal nozzle axis N by a linear actuator 50. In this example, the tapered surface 46 is linearly moveable along the longitudinal nozzle axis N. The linear actuator 50 in this example is a ball screw actuator, but this disclosure extends to other types of actuators. The linear actuator 50 is mechanically connected to the shank portion 42, which is in turn mechanically connected to the head portion 44.

The linear actuator 50 is responsive to commands from a controller 52, in this example. The controller 52 is shown schematically in FIG. 1. The controller 52 includes electronics, software, or both, to perform the functions described herein. Although it is shown as a single device, the controller 52 may include multiple controllers in the form of multiple hardware devices, or multiple software controllers within one or more hardware devices. The controller 52 may issue commands to various components of the vehicle 20 based on the output of one or more sensors, based on signals sent wirelessly to the vehicle 20, based on a preprogrammed flight plan, and/or based on other inputs.

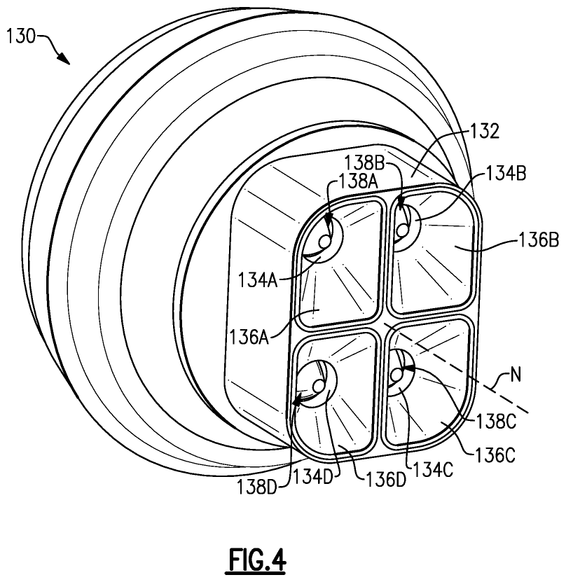

In this disclosure, the nozzle 32 and flow regulator 38 are mounted to the casing 24 via a rotary ball joint 54, which is perhaps best seen in FIG. 3. The rotary ball joint 54 is configured to selectively rotate the nozzle 32 and flow regulator 38 relative to the longitudinal vehicle axis R.

The rotary ball joint 54 includes a semi-spherical bearing (i.e., ball) 56 received in a semi-spherical socket (i.e., socket) 58 surrounding at least a portion of the bearing 56. In a particular example, the actuator(s) 60 are configured to move the bearing 56 in two planes, including by inclining the bearing 56 relative to the longitudinal vehicle axis R and rotating the bearing 56 about the longitudinal vehicle axis R. In this regard, the actuator(s) 60 are configured to move the bearing 56, and in turn the nozzle 32, about first and second axes, each of which is normal to the longitudinal vehicle axis R, and each of which is normal to one another. In an example, the first axis extends substantially in-and-out of the page relative to FIG. 1, and the second axis extends in an up-and-down direction relative to FIG. 1. The bearing 56 may be infinitely adjustable in these two planes relative to the socket 58, in one example. The socket 58 is sized and shaped to prevent translation of the bearing 56 relative to the socket 58 in any direction, including along the longitudinal vehicle axis R. Thus, in some examples, the rotary ball joint 54 is referred to as a trapped ball joint.

The bearing 56 is hollow and includes a central passageway 62 in this example. The nozzle 32 may be integrally formed with the bearing 56 in one example. Further, the flow regulator 38 is rigidly mounted in the central passageway 62 in this example. Thus, as the bearing 56 rotates within the socket 58, the longitudinal nozzle axis N will also rotate relative to the longitudinal vehicle axis R to provide thrust-vectoring as needed throughout a particular mission. The nozzle assembly 30, specifically the flow regulator 38 and the ball joint 54, can be controlled to provide pitch and yaw control of the vehicle 20 during the mission.

This disclosure provides adequate pitch and yaw control without requiring a large nozzle. Specifically, the length of the nozzle 32 is substantially reduced relative to existing nozzles. In one particular example, a length of the nozzle 32 is within 15-20% of the overall length of the vehicle 20. In a further example, the length of the nozzle 32 is less than 10% of the overall length of the vehicle 20. This, in turn, reduces the weight of the vehicle 20, and allows for designs in which the propellant storage tank(s) can be increased in size, providing for potentially longer missions.

Another example nozzle assembly 130 is illustrated in FIG. 4. To the extent not otherwise described or shown, the nozzle assembly 130 corresponds to the embodiment of FIGS. 1-3, with like parts having reference numerals preappended with a “1,” unless specified otherwise below.

The nozzle assembly 130 includes a plurality of flow regulators 138A-138D which are arranged relative to respective throat sections 134A-134D. The products of a combustion chamber may be divided into four equal parts, with each part flowing to a respective flow regulator 138A-138D. The nozzle 132 includes four divergent sections 136A-136D gradually increasing in diameter extending away from a respective throat sections 134A-134D.

The flow regulators 138A-138D are each arranged substantially similar to the flow regulator 38, and in particular are configured to move between closed positions and a number of open positions. The flow regulators 138A-138D are independently moveable by respective linear actuators, each similar to the linear actuator 50, in response to commands from a controller. Alternatively, the flow regulators 138A-138D are controlled in coordination with one another such that the flow regulators 138A-138D make substantially the same movements at substantially the same time. To this end, the flow regulators 138A-138D could be moveable by a common linear actuator. The flow regulators 138A-138D are arranged along respective axes, which are parallel to the longitudinal nozzle axis N and are circumferentially spaced-apart from one another about the longitudinal nozzle axis N. The flow regulators 138A-138D may be controlled in a way that controls the roll of a rocket during flight, thus eliminating the need for a separate roll control system. Thus, the nozzle assembly 130 may be able to control pitch, yaw, and roll. Further, by splitting the nozzle 132 into four sections, the nozzle 132 can be even shorter than the nozzle 32 in some examples, leading to increased space for propellant, for example.

It should be understood that except where otherwise noted, terms such as “axial,” “radial,” and “circumferential” are used above with reference to the normal operational attitude of the vehicle 20. Further, these terms have been used herein for purposes of explanation, and should not be considered otherwise limiting. Terms such as “generally,” “substantially,” and “about” are not intended to be boundaryless terms, and should be interpreted consistent with the way one skilled in the art would interpret those terms.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. A nozzle assembly, comprising:
a nozzle including a throat section, the nozzle including a ball portion of a ball and socket joint;
a vehicle including a socket portion of the ball and socket joint, wherein the nozzle is mounted to the vehicle and wherein the ball portion is received at least partially in the socket portion;
a flow regulator arranged adjacent the throat section and configured to regulate a flow of fluid through the throat section, wherein the flow regulator is attached to the nozzle upstream of the throat section; and
an actuator attached to the nozzle, wherein the actuator is configured to selectively rotate the nozzle via the ball and socket joint about a first axis normal to a longitudinal axis of the vehicle.

2. The nozzle assembly as recited in claim 1, wherein the actuator is further configured to selectively rotate the nozzle about a second axis normal to the longitudinal axis of the vehicle and the first axis.

3. The nozzle assembly as recited in claim 1, further comprising a plurality of nozzles and a corresponding plurality of flow regulators, each of the plurality of nozzles integral to the ball portion of the ball and socket joint.

4. The nozzle assembly as recited in claim 3, wherein each of the plurality of flow regulators is configured to operate either independent of one another or in coordination with one another.

5. The nozzle assembly as recited in claim 1, wherein the ball portion is a semi-spherical bearing and the socket portion a semi-spherical socket surrounding at least a portion of the ball portion.

6. The nozzle assembly as recited in claim 1, wherein the flow regulator includes a pintle moveable in a direction parallel to a longitudinal axis of the nozzle relative to a seat to regulate the flow of fluid through the throat area.

7. The nozzle assembly as recited in claim 6, wherein:
the pintle includes a includes a shank portion, a head portion having a greater diameter than the shank portion, and a tapered surface extending from the head portion,
the tapered surface is configured to contact the seat,
a linear position of the tapered surface relative to the seat changes a size of a flow area through which fluid can flow through the throat section.

8. The nozzle assembly as recited in claim 7, wherein the tapered surface gradually reduces in diameter from the head portion to a free end of the pintle.

9. The nozzle assembly as recited in claim 8, wherein:
the pintle is one of a plurality of pintles arranged adjacent the throat section, and
each of the plurality of pintles is independently moveable.

10. The nozzle assembly as recited in claim 9, wherein the plurality of pintles consists of four pintles spaced-apart from one another about the longitudinal axis of the nozzle.

11. The nozzle assembly as recited in claim 10, further including a plurality of linear actuators each configured to selectively move a respective one of the plurality of pintles.

12. The nozzle assembly as recited in claim 1, wherein the nozzle includes a divergent section extending from the throat section.

13. The nozzle assembly as recited in claim 1, wherein the vehicle is a rocket engine.

14. A rocket, comprising:
a body;
propellant stored within the body;
a combustion chamber arranged within the body; and
a nozzle assembly attached to the body and configured to expel the products of the combustion chamber, the nozzle assembly including:
a nozzle including a throat section;
a flow regulator arranged adjacent the throat section and configured to regulate a flow of the products of the combustion chamber through the throat section; and
a rotary ball joint configured to selectively rotate the flow regulator and nozzle.

15. The rocket as recited in claim 14, wherein the flow regulator includes a pintle linearly moveable relative to a seat.

16. The rocket as recited in claim 15, wherein:
the pintle is one of a plurality of pintles arranged adjacent the throat section, and
each of the plurality of pintles is independently moveable by a respective linear actuator.

17. The rocket as recited in claim 16, wherein the plurality of pintles consists of four pintles spaced-apart from one another about a longitudinal axis of the nozzle.

18. A method, comprising:
thrust vectoring a body by adjusting a position of a nozzle relative to the body via a rotary joint and adjusting a position of a flow regulator arranged adjacent a throat section of the nozzle.

19. The method as recited in claim 18, wherein the flow regulator includes a pintle, and wherein adjusting the position of the flow regulator includes linearly moving the pintle in a direction parallel to a longitudinal axis of the nozzle.
